(19) United States
(12) Patent Application Publication
(10) Pub. No.: US 2014/0311099 A1
(43) Pub. Date: Oct. 23, 2014

(54) PACKAGING CONTAINING OXYGEN SCAVENGING COMPOSITIONS

(71) Applicant: E I DU PONT DE NEMOURS AND COMPANY, Wilmington, DE (US)

(72) Inventor: Julius Uradnisheck, Glen Mills, PA (US)

(73) Assignee: E I DU PONT DE NEMOURS AND COMPANY, Wilmington, DE (US)

(21) Appl. No.: 14/244,008

(22) Filed: Apr. 3, 2014

Related U.S. Application Data
(60) Provisional application No. 61/812,861, filed on Apr. 17, 2013.

(51) Int. Cl. B65D 81/26; B65B 25/00; B32B 1/02; B32B 27/08; B32B 27/32; B32B 27/30

(52) U.S. Cl. CPC B65D 81/266; B32B 27/32; B32B 27/306; B32B 1/02; B32B 27/08; B65B 25/00
USPC 53/440; 428/523; 428/516; 428/66.4; 428/35.7; 428/36.7; 53/428; 252/188.28

(57) ABSTRACT

An oxygen scavenging composition capable of providing good oxygen absorption capabilities wherein the oxygen scavenging agent is a sulfite salt with a Group I cation, combined with an acidifying agent and optionally a hygroscopic salt. The compositions can be formed into films, coatings, 3-dimensional solids, fibers, webs, and shaped products or structures which are incorporated into, applied to, or otherwise become a part of a container structure, including container closures, seals, gaskets, liners, and the like.

### CROSS REFERENCE TO RELATED APPLICATION

This application claims priority to U.S. provisional application Ser. No. 61/812,861, filed Apr. 17, 2013; the entire disclosure of which is incorporated herein by reference.

### FIELD OF THE INVENTION

This invention relates to compositions useful for retaining product quality and improving shelf life of oxygen sensitive materials.

### BACKGROUND OF THE INVENTION

Some packaged food products are susceptible to degradation by oxygen. When conventional containers are used for the storage of oxygen sensitive materials, the shelf life of the stored materials is limited. The quality of the packaged material tends to deteriorate over time, in part because oxygen typically is present in the package from the time it is filled; and in part due to oxygen ingress which occurs during storage. Minimizing oxidation of the food will help to prevent their degradation. Changes in color, nutritive value and flavor may be associated directly with degradation due to oxygen combining with the food.

Various packaging means have been used to reduce exposure of oxygen-sensitive products to oxygen. For example, food has previously been packaged in containers formed of a glass or metal body and provided with a hermetically sealed metal closure. As a practical matter, metal cans reliably prevent oxygen ingress. However, some oxygen ingress may occur by diffusion through the gasket or the like positioned between a container body and its lid.

Because metal cans are heavy, packages have been developed from lighter weight polymeric materials. In order to enhance preservation, it is standard practice to package food and other materials within laminated packaging material that generally includes a barrier layer having a low permeability to oxygen. The sheet material can be thin, in which event it is wrapped around the material being packaged, or it can be sufficiently thick that it forms a shaped container body that is provided with a lid or other separate closure. The polymeric sheet material may constitute some or all of the interior exposed surface area of the container or its closure means. Also, such barrier materials have been used or suggested in multilayer structures together with oxygen scavenging systems in order to absorb any oxygen which might pass through the barrier or remain in the head space above the packed and processed food or beverage.

In other packaging designs that control oxygen ingress the container might be a can or bottle of metal, glass or multilayer polymer containing an oxygen barrier layer. The design might have the greatest location of oxygen ingress as a radial diffusion across a non-barrier layer such as a seal in the metal bottle cap or can liner. The seal by design might need to be soft to provide a complete seal against the lip of the glass or plastic bottle or metal can, but it most often is a poor oxygen barrier. An oxygen scavenger additive to the composition of the seal would limit oxygen diffusion radially across the seal and above the lid of the container for a limited time as required by the shelf-life goal for the can or bottle.

Containers used to pack foods are often subjected to aggressive processing conditions such as during retorting (high pressure steam sterilization at 121° C.) for purposes of sterilizing the packaged food. Retortable containers and their methods of manufacture are disclosed for example in PCT publications WO81/00230 and WO81/00231.

An example oxygen barrier material is ethylene vinyl alcohol copolymer (EVOH). However, when food or other packaged material is retorted the EVOH used to protect the food from oxygen is damaged and does not protect the contents of the package from oxygen ingress for several weeks or months. The phenomenon is called “retort shock”.

Currently converters who make multilayer articles use extra-thick layers of EVOH to counteract the retort shock deficiency of EVOH. This approach is costly since EVOH is the most expensive component of multilayer packages. Alternatively converters position the EVOH layer nearer the outside surface instead of the center in order to allow the EVOH to dry out faster after retort. However unbalanced sheeting is susceptible to curl, making its handling difficult.

A barrier compound to react with oxygen is commonly called an “active barrier”. The use of an active barrier with a passive barrier (i.e. EVOH) can temporarily block oxygen ingress when EVOH experiences retort shock. For example, U.S. Pat. No. 4,048,361 discloses a food container formed with a barrier material inside of which is a carrier layer containing a “getter”. The getter may be an absorbent for any gas which permeates the barrier layer. An alternative approach includes a barrier layer having on both sides a carrier layer whereby oxygen leaving the head space or coming from the outside will be slowly absorbed by the getter.

Antioxidants have been added to polymeric resins to be formed into containers, and to the materials to be contained therein, to inhibit oxidation. For example, U.S. Pat. No. 3,586,514 discloses the use of antioxidants mixed with a plastic barrier layer to reduce the permeation of oxygen to beer within a container. U.S. Pat. No. 3,429,717 discloses a barrier comprising the barrier resin Saran® in a film sandwich with an antioxidant uniformly distributed between the layers of Saran®.

It is also known that certain antioxidants also have an ability to react with oxygen, but usually only to a very limited extent. There is a difference between direct oxygen absorption and the action of typical antioxidants such as propyl gallate, and butylated hydroxyanisole, di-tertiary-butylparacresol (see U.S. Pat. No. 4,048,361). Typical antioxidants operate in a manner different from direct oxygen absorbers or scavengers. More specifically, antioxidants are usually present in small percentages to terminate the degradation process of the material into which it is mixed i.e., the plastic package itself or the contents. A direct oxygen scavenger is capable of reacting at a significant rate with a much larger amount of oxygen than antioxidants would and is also employed in relatively large concentrations. The chemical distinction is that oxygen absorbers react chemically only with oxygen (di-oxygen). Antioxidants may react with oxygen radicals created by the reaction between di-oxygen and organic compounds, but the primary action of an antioxidant is to interfere with the free-radical chemistry involved in oxidative degradation.

It is known to include an oxygen scavenger agent in one or more layers of a multilayer sheet material. The oxygen scavenger agent reacts with oxygen that is trapped within the contents enclosed by the package or that permeates through the walls of the package. This is described in, for instance, U.S. Pat. Nos. 4,536,409 and 4,702,966 and the prior art discussed in these references. U.S. Pat. No. 4,536,409, for example, describes cylindrical containers formed from such sheet material and provided with metal lids.

Various oxygen scavengers are known in the art. Sulfite salts are disclosed as oxygen scavenging chemistry in several patents. For example, U.S. Pat. No. 2,825,651 discloses an oxygen remover system which includes hydrates, for example, an anhydrous sodium sulfite catalyzed by copper sulfate pentahydrate. Such an oxygen remover is included as a pellet inside a protective package for placement in the container head space. U.S. Pat. No. 4,536,409 discloses potassium sulfite as a scavenger. See also WO89/02709 and EP0083826.

U.S. Pat. No. 4,041,209 discloses an aqueous solution of a reducing sulfite salt disposed between a high barrier outer layer, thereby retarding inward oxygen flow from the outside and a low barrier inner layer that permits oxygen to permeate outward from the head space so that the solution can react with the permeated oxygen.

EP1577349 describes a water-absorbing resin composition comprising oxygen scavenging iron, an oxygen-containing reducing inorganic salt such as sulfites, including calcium sulfite, and a water absorbent resin and articles therefrom.

A deficiency of the prior art materials is the release of sulfite anion into food during the 30- to 45-minute duration of a retorting process. Sulfite can be generated by natural processes in some foods and has a long history as a food additive for preservation; however, sulfite-containing foods can have an adverse effect on some consumers. To minimize adverse effects, the U.S. and European Union regulations now prohibit additions of sulfite to some foods and/or require foods to be labeled when sulfite is present at certain levels. USA Food and Drug Administration regulations require a labeling of “sulfite addition” above certain levels (around 10 ppm). Sulfite in food is also regulated by the European Union using the advice of the European Food Safety Authority which reports sensitivity to sulfite can be below the 10 ppm level. EP1071724 describes the problems of sulfite migration and describes mixtures of bisulfite and talc to minimize migration.

U.S. Pat. No. 6,007,885 discloses an oxygen scavenging composition wherein the oxygen scavenging agent is a hydroxosulfitometalate. EP 1109667 A4 (text from WO1999047351A1) and EP 1050556 B1 referring to hydroxosulfitemetalate as a composition that can scavenge oxygen while meeting the regulatory standards limiting migration of chemicals into food.

A successful oxygen scavenger system desirably remains inactive or inert, in order to preserve its oxygen scavenging capacity, until such time as food is sealed within the container. Containers often sit empty in warehouses for several months before use. There is a need for means by which the scavenger contained in a multilayer container will be maintained inactive until such time as the oxygen scavenging activity is most beneficial.

U.S. Pat. No. 4,113,652 discloses an oxygen absorbant comprising at least one alkaline earth metal sulfite, at least one ferrous compound and free water. It also teaches that the presence of ammonium salts or water in an oxygen scavenger can lengthen the period before the oxygen scavenger becomes effective. Increasing the amount of water or ammonium salts in the oxygen scavenger extends its period of latency.

EP0204324 discloses a resin laminate comprising a gas permeation-resistant layer having laminated on each side thereof a polyolefin based resin layer and an adhesive layer between the gas permeation-resistant layer and the polyolefin based resin layer. Each polyolefin layer contains inorganic filler including, among many other examples, calcium sulfite.

Similarly US2012/0291405 discloses a multilayered packaging material comprising a first layer of an oxygen barrier material and a protective material bonded to the first layer comprising a polymer and inorganic filler in an amount sufficient to further enhance the moisture barrier property of the protective layer over what it would be in the absence of the filler. The inorganic filler may be, among many other examples, calcium sulfite.

Systems for inclusion in a package within a container that react in the presence of the moisture in the food have been disclosed. For example, DE28272467 discloses the potential of a wet (sodium) sulfite salt for oxygen absorption. According to German OS 28 27 247 the sulfite salt is wetted by a deliquescent salt with which it is mixed. Some water-soluble sulfite salts can become highly reactive in this dissolved state.

JP52114487A discloses an oxygen absorbent comprising calcium sulfite, activated carbon, sodium dithionite, and a specific oxidation accelerator, which can absorb oxygen in an atmosphere where moisture is present over a long period.

### SUMMARY OF THE INVENTION

The invention provides an oxygen scavenging composition comprising or consisting essentially of
(a) a sparingly soluble salt of a divalent cation selected from Group HA of the periodic table and sulfite;
(b) an acidifying compound, characterized by the condition that the pH of a solution of 0.1 grams of the acidifying compound in 10 grams of deionized water after 2 minutes of stirring is from about 2 to about 6; and optionally
(c) a hygroscopic compound characterized by the condition that the relative humidity above a supersaturated solution of the hygroscopic compound is less than 30%;
wherein the pH of a solution of 0.1 grams of the mixture of (a), (b), and (c) in 10 grams deionized water after 2 minute stirring is in the range from 2 to 7; provided that (b) and (c) are not ferrous compounds.

The invention also provides a composition comprising the oxygen scavenging composition described above in a polymer matrix.

The invention also provides a method for protecting a food item from degradation due to oxidation comprising
(1) preparing a package comprising the oxygen scavenging composition of claim 1;
(2) placing the food item in the package; and
(3) sealing the package with the food item inside.

### DETAILED DESCRIPTION OF THE INVENTION

The teachings of each of the references cited herein above are incorporated herein by reference in their entirety.

It is desirable to protect food from oxygen, such as during the time an EVOH barrier is disrupted by the retort process, while avoiding the use of transition metals in the food package, generation of odor or flavor effects and introduction of too much sulfite into the contained food. As used herein, transition metals are those metals such as iron that give rise to cations with incompletely filled d-orbitals (the zinc cation has completely filled d-orbitals and is not a transition metal under this definition). It is also desirable that the oxygen-protecting material is stable prior to being initiated to start scavenging oxygen by the retort process itself. Preferably the oxygen-protecting material may be incorporated into the packaging structure by a melt-processing method allowing the use of existing low-cost packaging resins, and provide an aesthetically pleasing white color to the package.

The composition disclosed herein has been unexpectedly found to provide a desirable means of providing a large degree of oxygen scavenging activity and thereby provide enhanced capacity and activity to scavenge oxygen while not allowing the initial oxygen scavenging material and/or any resultant oxidation by-product to migrate into or adversely affect the color, taste or smell of articles in contact with the subject composition. It has been found that the oxygen scavenger composition can be used for the preservation of oxygen sensitive foods that have been retorted and then stored at ambient conditions. The present composition has an advantage over other oxygen scavenger compositions directly mixed into and forming a filler of a polymer matrix because the present compositions inhibit the release of scavenger agent and/or oxidation byproducts which may contaminate the food material. The scavengers of the invention also provide an advantage in that they do not require milling to achieve high oxygen scavenging capability. The scavengers are particulate material that contains, as a part of their composition, a moisture-activated oxygen scavenging moiety. The oxygen scavenging system does not need added free water, but is activated by the presence of moisture absorbed from the surroundings. It has been found that the nature of the system is such that the oxygen scavenging agent is highly reactive with molecular oxygen yet is sufficiently insoluble that substantial migration of the oxygen scavenging moiety or its oxidized product into the packaged material is prevented. Therefore, this invention unexpectedly provides a highly desired oxygen scavenger composition which does not cause discoloration or detract from taste of the packaged food product.

Prior art sulfite scavengers include highly soluble salts such sodium sulfite or potassium sulfite. It has been discovered that the benefit of solubility for immediate scavenging is also a deficiency for release of sulfite into food during the relatively brief retort process. Calcium sulfite solubility is 10,000 times lower than that of sodium sulfite and it would not be expected to react with oxygen due to its low solubility. Whereas calcium sulfite is found for all practical purposes not to react with oxygen, a composition based on calcium sulfite has been discovered wherein, surprisingly, the sparing solubility of calcium sulfite is found to be beneficial for minimal migration of sulfite into food and nevertheless scavenge oxygen.

While some conventional oxygen scavenging agents degrade when subjected to elevated temperatures, the subject oxygen scavenger agent has been found to be stable to elevated temperatures commonly experienced in processing polymers into films or coatings, pasteurization, sterilization and the like processes commonly encountered in packaging technology.

The measured sulfite or sulfate migration during the retort process is greatly reduced using the formulated sparingly soluble sulfite salts with acidifying compounds compared to soluble sulfite salts, while at the same time oxygen scavenging rate and capacity of the sparingly soluble salt is similar to a highly soluble sulfite salt.

Compositions comprise an oxygen scavenging system that provides the ability to combine chemically with oxygen in the interior of containers and optionally a carrier that avoids undue migration of the oxygen scavenging agent or its oxidation by-product(s) such as sulfate from the carrier. The inhibition of migration significantly reduces or eliminates adverse effects on the color, taste, or smell of articles in contact with the polymer carrier. High levels of the scavenging agent, which may be triggered by moisture, can be used without fear of having excessive amounts of the agent becoming an extraneous material in the packaged food article.

The oxygen-scavenging system comprises sparingly soluble salt of a divalent cation selected from Group IIA of the periodic table and sulfite. This component of the system may be in the form of an inorganic sulfite salt such as calcium sulfite that is sparingly soluble in water. As used herein, the term “sparingly soluble” means solubility at ambient conditions in water of initial neutral pH of less than 1 g per 100 ml, less than 0.7 g per 100 ml, or less than 0.1 g per 100 ml. Furthermore and importantly the sparingly soluble sulfite salt is accompanied by an acidifying compound that preferably does not contain any transition metal, such as aluminum potassium sulfate or disodium EDTA and optionally a water attracting compound such as potassium acetate or zinc chloride.

The sparingly soluble salt may be included in the oxygen scavenging composition by the addition of a salt comprising a divalent cation selected from Group HA of the periodic table and sulfite, such as magnesium sulfite or preferably calcium sulfite. Calcium sulfite is particularly well suited for use as an oxygen scavenger because when formulated with certain acidifying compounds it can be readily triggered by the retort process and has enough thermal stability to permit its use at the high temperatures of thermoplastic processes such as injection molding. Also, it has been discovered that when within a polymer environment such as polypropylene the retort-activated calcium sulfite becomes inactive when the sheet is dried and cooled to ambient conditions.

Alternatively, the sparingly soluble salt may be made from a blend of salts so that divalent cations selected from Group HA of the periodic table and sulfite ion are present in the oxygen scavenging composition. For example, a blend of sodium sulfite and calcium chloride may be combined. Following activation as described below, sufficient calcium sulfite may be formed to allow for the system to scavenge oxygen.

The oxygen scavenging system also comprises an acidifying compound, characterized by the condition that the pH of a solution of 0.1 grams of the acidifying compound in 10 grams deionized water after 2 minute stirring is from about 2 to about 6, preferably from about 4 to about 6. An optimally acidic environment is found to enable a controlled dissolution of calcium sulfite so that oxygen scavenging can progress after retorting process with minor release of sulfite into food during the retort process. Examples of acidifying compounds include organic acids such as stearic acid or adipic acid, or alum (aluminum potassium sulfate·12H₂O), and salts of ethylenediaminetetraacetic acid. Alum is a preferred acidifying compound. The mole ratio of acidifying compound to sulfite may be from about 0.01 to about 2.

The scavenging composition provides a chemical system that reacts with oxygen only when the sparingly soluble sulfite is contacted by water or moisture. Without being bound by theory, the mechanism of scavenging may require a first association of the sulfite anion with water followed by its reversible reaction with water to give hydrosulfite. Thus, aqueous hydrosulfite ion may be the actual scavenging agent. Oxygen can react with hydrosulfite anion resulting in the formation of sulfate ion and water. This mechanism implies the environmental requirement for oxygen scavenging using sulfite is the presence of a certain amount of water and acidity to drive the sulfite toward hydrosulfite. However, water is not formulated with the scavenger system to preclude premature oxygen absorption. Sufficient water may be obtained from the surrounding environment to trigger scavenging under conditions when scavenging is desired.

Optionally, the oxygen scavenging system may comprise a hygroscopic compound. The term “hygroscopic” relates to the ability of a compound to absorb or adsorb water from its surroundings. As used herein, a hygroscopic compound is one in which the relative humidity above a saturated solution of the compound is below 30%. Preferred hygroscopic compounds include acetate salts such as potassium acetate or zinc acetate. When present, the mole ratio of hygroscopic compound to sulfite may be from about 0.01 to about 1. When used, the type and amount of hygroscopic compound is selected so that the combination with the sulfite salt and the acidifying component is acidic. The hygroscopic compound may help bring water into the presence of the oxygen scavenging agent.

To provide good oxygen scavenging, (a) sparingly soluble sulfite salt, (b) acidifying component and (c) optional hygroscopic compound are combined so that the pH of a solution of 0.1 grams of the mixture of (a), (b), and (c) in 10 grams deionized water after 2 minute stirring is in the range from 2 to 7, preferably 4 to 6 or 3 to 5.

Desirably, the oxygen scavenging system is not activated before the food is packed and retorted. So, containers having an oxygen absorbing system should be capable of being made and stored with the oxygen absorbing system in an inactive state until the precise time at which the oxygen absorption is required, at which time the system will be activated. Without a triggerable or activatable scavenging system having inactive and active states, severe depletion of its usefulness could occur during empty storage prior to packing The benefit of any oxygen scavenging system without triggering would be limited and would necessitate prompt use of the container following its manufacture. Such a limitation is impractical in connection with commercial use and procedures for packaging of food.

The oxygen scavenger composition described herein is stable until activated to scavenge oxygen within a package by water. The oxygen scavenger can be successfully activated simply and conveniently when its greatest need begins. Activation is not occasioned merely by filling the container. If the sparingly soluble sulfite composition is free of polymer carrier or carried within a water-permeable polymer the activation for scavenging can be a mild condition such as 100% relative humidity at room temperatures. Exposure of the composition to high humidity such as nearly 100% relative humidity that normally exists within a sealed container of moist food for example, therefore, could result in sufficient time and permeation of moisture into the composition and cause the subject oxygen scavenger to initiate a satisfactory degree of scavenging. This will result in improved shelf life of the packaged material.

However, exposure of a hydrophobic polymer such as polypropylene or high density polyethylene composition to high humidity or even hot water requires far greater time (such as days) to activate the scavenging reaction. The system can involve triggering activation by the ingress of moisture through the walls of a polymeric container. This moisture ingress occurs very slowly at ambient temperature and humidity conditions but rapidly during sterilization or retort. The oxygen scavenger remains substantially inert in the composition and in a gasket or other solid deposit formed with the subject composition until the composition is on or in a sealed container or closure.

The scavenging reaction can be accelerated by heating the composition sufficiently while in the closed container to cause increased permeation of moisture. Elevated temperature (such as 121° C.) and high water thermodynamic activity (such as water vapor saturation) during retorting or sterilization are the key variables that speed up permeation of water into the oxygen absorber to activate it when it is carried within hydrophobic polymers such as polypropylene or high density polyethylene. More specifically, the oxygen absorber when within a hydrophobic polymer at ambient conditions is not active or is very slow in its reaction with oxygen but upon contact with moisture resulting from normal retort processing it becomes activated and begins to react rapidly with oxygen until either oxygen or the sulfite scavenger is consumed or if it is again dried. For example, the steam retort process normally used for food contained in polypropylene cups or trays will activate the oxygen scavenging composition whereas the unfilled cups or trays can remain essentially inactivate in storage. Thus, the oxygen scavenging agent preferably remains substantially inert in or on the carrier until the scavenging reaction is initiated by moisture.

The liquid water environment within a hydrophobic polymer is found to require a significant driving force such as is present during a 30 to 60-minute steam retort to enable activation. It is believed that the addition of components that attract water such as those compounds having low relative humidity in equilibrium above their saturated solutions aids in attracting moisture. The selection of the water attracting component must avoid interfering with the chemical mechanism of oxygen scavenging by the sparingly soluble sulfite salt. For example, the hygroscopic compound should provide that the overall composition remain slightly acidic for effective scavenging.

The concept of triggering is appreciated only in part by U.S. Pat. No. 2,316,804 where materials that do not have antioxidant activity when initially applied to metal cans, in the presence of elevated temperatures, develop marked oxygen scavenging effects. The materials described are inappropriate for containers formed by melt extrusion, however, since the high temperatures of melt extrusion manufacture would activate the oxygen absorption prematurely.

The present composition can be used as part of a package container which can provide storage stability to the material packaged therein without detracting from the material's taste, odor or smell. The composition should be exposed to the inner atmosphere of the resultant sealed container in any form such as a coating on all or a part of the inner surface of the container body or closure means (e.g., lid, can end) or as an insert in the form of a film, mat, pouch, sachet, coated or porous ceramic structure.

The scavenging system can be used as neat material or contained within a polymer matrix. The oxygen scavenging agent has been found to provide effective oxygen scavenging activity and rate when the agent is placed in the presence of oxygen and sufficiently high moisture. Thus, prior to their incorporation into a polymer the oxygen scavenging composition preferably should be maintained in the absence of either moisture or oxygen during formation and storage. Once melt processed into hydrophobic polymers the composition is stabilized against reacting with oxygen even at high ambient humidity. However, if processed into a hydrophilic material such as cellulose or polyvinyl alcohol the composition might need protection from either oxygen or high moisture. If the present agent is formulated into an oxygen scavenging composition with a carrier, such as a polymeric matrix that acts as a concentrate, the formulated carrier preferably should be stored in a way so as to maintain the agent substantially free from moisture to the degree needed to trigger (initiate) a high rate of oxygen scavenging to occur to provide preservation of the packaged goods contemplated. The carrier therefore is preferably a hydrophobic polymer or the concentrate is desirably stored away from high moisture and/or away from oxygen.

An exemplary scavenger is a finely divided solid that is particularly suited to be used in seal, coating, or film compositions which are applications contemplated herein. The subject composition as a whole is effectively anhydrous, that is, it provides a moisture content lower than needed to trigger (initiate at a substantial rate) oxygen scavenging.

For example, a moisture permeable pouch, sachet or capsule containing the oxygen scavenging composition as polymer-free powder or granules may be used to consume oxygen entrapped during the closure process of containers made of metal, glass or plastic. The pouch, sachet or capsule should be sufficiently permeable to permit moisture to penetrate through to the oxygen scavenging composition at conditions post-sealing and prior to storage and of suitable physical size to be inserted in a container having an oxygen sensitive material therein. Preferably, for packages that are not retorted after sealing, the material for the pouch, sachet or capsule has a water vapor transmission rate (WVTR) greater than about 10 g-water·mil (thickness of the material wall)/100 inch²(surface area of the scavenger container)·day at 90% relative humidity and 37° C. For retorted packaged the WVTR values for the pouch, sachet, or capsule material containing the scavenger can be as low as 0.3 g mil/100 inch²·day. The oxygen permeation rate for the pouch, sachet, or capsule should be greater than about 200 cc-oxygen mil/100 inch²·day·atm. The pouch, sachet or capsule can be made from natural or synthetic materials such as paper, cotton cloth, polymer films and the like in manners well known to the packaging technology.

Alternatively, the oxygen scavenging composition might be contained within pellets of a material. The pellet material might allow rapid humidification for the scavenger such as starch, or polyvinyl alcohol. The material might allow rapid diffusion of oxygen such as very low density polyethylene, thermoplastic elastomer, poly-4-methylpentene-1 or silicone elastomer. Materials such as cellulose may allow both rapid humidification and rapid diffusion of oxygen.

The carrier can, alternately, be in the form of a fibrous (woven or non-woven) mat. The oxygen scavenger composition is contained in the interstices of the mat structure. The fibers forming the mat may be formed from any suitable material or synthetic fiber such as cotton, glass, nylon, polyethylene, and copolymers of ethylene with one or more ethylenically unsaturated monomer, polypropylene and copolymers of propylene with one or more ethylenically unsaturated monomer and the like. The particular nature of the carrier mat will depend upon the application of its use and the ability of the mat to retain oxygen scavenger material within the interstices of the mat structure during use. The scavenger can be deposited into the mat structure by any means such as by dipping the mat into a dispersion or suspension of the scavenger and then removing the liquid from the mat or by first forming particulates of scavenger/polymer composition which is melt deposited onto and into the mat structure.

The carrier may be in the form of a porous inorganic material, such as an open porous ceramic having the oxygen scavenger agent distributed therein. The ceramic can be formed into any desired shape (e.g., spheres, cubes, cylinders and the like) and size which is suitable for insertion into the container having the oxygen sensitive material. Useful porous inorganic materials include conventional clay, cement pastes, molecular sieves, diatomaceous earth, and the like. The scavenging composition may be formulated in any convenient form, such as a melt, organic solution, dry blend, or dispersion. The main ingredients of the composition, apart from the oxygen scavenger agent, may comprise conventional materials provided they allow the solubilization of the sulfite scavenger. They should allow the scavenging composition to develop acidic pH and should not have an excess of soluble Group II cations. It is preferred that the total composition should be non-aqueous (i.e., an anhydrous solution, plastisol or thermoplastic melt) so as to prevent initiation of the reaction of the scavenging agent within the composition.

The carrier may be selected from those used to form coatings on at least a portion of the interior surface of a package (e.g., a rigid container such as a can, can lid, box, carton, or the like). A polymeric carrier may be mixed with the above described oxygen scavenger agent to provide an encapsulated particulate which may be subsequently used in a second carrier or applied onto (such as by solvent or melt application) the surface of a second carrier material.

Preferably the carrier component of the composition is a polymeric matrix (i.e., a three-dimensional structure into which the scavenger is incorporated). The polymeric matrix material may be chosen from at least one polymeric material that can form a solid or semi-solid matrix. The polymeric carrier can be derived from a variety of polymers which are available from a variety of bulk physical configurations such as aqueous dispersion, dry blend, solution, or a melt (e.g., a thermoplastic melt-processible polymer). The particular physical configuration of the polymer selected will depend on the end structure into which the subject composition is eventually formed or incorporated. The polymeric matrix is derived from polymer types which may be thermoplastic or thermosetting.

When used in combination with a polymer matrix, the oxygen scavenging composition affords simple, reliable container constructions, including ones of multilayer form, that are low in cost. Generally, the polymeric matrix substantially protects the scavenger from moisture under normal atmospheric conditions and, therefore the oxygen scavenger agent remains substantially inert to scavenging activity. However, once a high degree of moisture is attained, as in a closed package environment of food products or during steam retorting of the package, the scavenging activity is initiated or triggered. A carrier comprising a polymeric matrix should be sufficiently permeable under triggering conditions to permit moisture and oxygen to pass into the matrix to contact the particulate scavenger material. Moisture ingress into the polymeric matrix carrying the scavenger may optionally be accelerated by hot filling, sterilization, pasteurization, retort, and the like. The moisture permeability of polypropylene is high enough for rapid (i.e. <30 minutes) activation of the scavenger during retorting; however higher moisture permeability than that of polypropylene would be needed for rapid activation by 100% relative humidity at 22° C. or by 70° C. water.

The polymer matrix can comprise one or more polymers and optional additives (e.g., fillers, surfactants, plasticizers, stabilizers, antioxidants and others, provided the additives do not cause an overall alkaline effect with the oxygen scavenging system or have an excess amount of soluble Group II cations) forming a matrix in which the subject particulate scavenger material is substantially uniformly distributed, or a film or mat (woven or non-woven) having the subject particulate scavenger material substantially uniformly distributed therein and/or deposited thereon.

The polymeric composition can be used to form a carrier film which carries the present oxygen scavenger agent. The carrier can be formed from a polymeric material, such as those described above, capable of forming a film and upon the surface thereof is deposited the present oxygen scavenger. The film may be composed of a single layer or of a plurality of layers. The surface of the film can be coated with the subject oxygen scavenger agent by forming a suspension or dispersion of the particulate in a polymer and depositing the suspension or dispersion by a conventional means, such as spraying or knife coating application or the like, directly onto the film surface. The particular nature of the carrier film will depend upon the application contemplated and the ability of the carrier formed to have the oxygen scavenger adhered to its surface and substantially retain its integrity during use. The coated film may be further modified after coating with the scavenger composition. For example, additional layers of material may be coated or laminated to the carrier film to cover the scavenger coating to provide protection of the scavenger from moisture until activation is desired.

Preferably, the oxygen scavenging composition is dispersed in the polymer matrix, limiting its exposure to oxygen and moisture until needed. An exemplary composition comprises a carrier, preferably comprising at least one polymer and optionally one or more additives; a sparingly soluble sulfite salt which is the active ingredient for reacting (being oxidized) with oxygen, an acidifying component (i.e. gives an acidic pH when mixed with water, the sparingly soluble sulfite salt, and the optional water attractor), and optionally a water attracting component that does not counterbalance the acidic properties of the sparingly soluble sulfite salt and acidifying chemical and does not introduce an excess of soluble Group II cations (which are believed to interfere with the solubilization of the sparingly soluble sulite salt). The amount of oxygen scavenger may be from 0.05 to 50% weight based on total weight of the oxygen scavenging matrix composition, and the carrier comprises at least one polymer conventionally used in packaging, containers, and container closures, including gaskets, seals, cap disk liners, and the like. Preferably the polymeric carrier is a thermoplastic resin melting between 30 and 350° C. (such as between 100 and 290° C.).

The primary functions served by the polymer matrix are to provide a compatible carrier (a material which is stable under normal packaging temperature conditions and does not deactivate the oxygen scavenger agent) for the oxygen scavenging agent as described herein and to permit ingress of both oxygen and water into the composition in the desirable short time and to permit them to come into contact with the oxygen scavenging agent. The scope of the polymer(s) in general can be very broad. However, the polymer matrix may also be selected to perform additional functions depending on the physical configuration in which it is provided in a final structure into which it is shaped or incorporated. Thus, the particular polymer or mixture of polymers selected ultimately will be determined by the end use.

Suitable materials for use in thermoplastic compositions include the materials proposed in U.S. Pat. Nos. 4,619,848; 4,529,740; 5,014,447; 4,698,469; Great Britain Patents GB 1,112,023; GB 1,112,024; GB 1,112,025 and EP 129309.

General arrangement and ratios of polymers in a multilayer package must take into account the mechanical rigidity needs at the relatively high temperature of steam retort. For example, some portion of the multilayer polymer structure must not melt below 121° C. In particular, the polymeric material that carries the oxygen scavenging composition can be generally selected from polyolefins as, for example, polyethylene, polypropylene, ethylene/propylene copolymers, acid modified ethylene/propylene copolymers, polybutadiene, butyl rubber, styrene/butadiene rubber, carboxylated styrene/butadiene, polyisoprene, styrene/isoprene/styrene block copolymers, styrene/butadiene/styrene block copolymers, styrene/ethylene/butylene/styrene block copolymers, ethylene/vinyl acetate copolymers, ethylene/alkyl acrylate and ethylene/alkyl methacrylate copolymers (for instance, ethylene/butyl acrylate or ethylene/butyl methacrylate copolymers), ethylene/vinyl alcohol copolymers, ethylene or propylene/carbon monoxide alternating copolymers, vinyl chloride homopolymers and copolymers, vinylidene dichloride polymers and copolymers, styrene/acrylic polymers, polyamides, and blends of one or more of these.

Unsuitable polymers would be those that are not stable in the presence of slightly acidic conditions such as certain polyacetals and polyglycolic acid.

Polyethylenes include high density polyethylene (HDPE), low density polyethylene (LDPE), linear low density polyethylene (LLDPE), ultra-low density polyethylene (ULDPE) and the like as well as copolymers formed from ethylene with one or more other lower alkenes (e.g., octene) and the like. The polyethylene, if used for example as a gasket, is preferably a low density polyethylene, and may be a very low or ultra low density polyethylene which may be branched or linear. For moisture activation of the scavenging composition within 30 minutes, polypropylene has sufficiently permeability to moisture driven by steam retort conditions (121° C., saturated steam, and 30-minute duration) and insufficient permeability for moisture at 22° C., 100% relative humidity, and 24-hour duration.

The ethylene/vinyl acetate copolymer, if used, preferably has a melt index in the range 3 to 15, preferably 5 to 10, and generally contains 5 to 40%, preferably 5 to 30%, vinyl acetate.

The carriers may further contain inert filler, slip aids, process aids, pigments, stabilizers, antioxidants, tackifying resins, foaming agents and other conventional additives in conventional amounts, depending upon the nature of the composition and its final use. Because alkalinity can slow or deactivate the sulfite scavenger, additives that cause alkalinity are preferably avoided or used minimally or with higher amounts of acidifying additive. If the carrier comprises a thermoplastic polymer, the total amount of such additives is generally below 10%, preferably below 3%, based on the total weight of the composition. However, when the carrier is in the form of a dispersion or organic solution or the amounts of additives based on total weight of the composition may be higher. When an antioxidant is incorporated, it should be present in amounts capable of stabilizing the polymeric composition against degradation due to free-radicals formed during processing. Furthermore some antioxidants may slow the sulfite scavenging reaction since the reaction apparently progresses through a hydrosulfite anion radical. However, the amount of antioxidant should be small enough to permit the subject oxygen scavenger agent of the composition to effectively react with molecular oxygen. The specific amount will depend on the antioxidant used.

Plasticizers include phthalates, adipates, glycols, citrates (selected so as not to interfere with the acidifying effects of acidifiers) and epoxidized oils and the like. Examples include dioctyl phthalate, diisooctyl phthalate or diisodecyl phthalate, which are readily available. Other usable plasticizers are butyl benzyl phthalate, acetyl tributyl citrate, ethyl diphenyl phosphate and diisobutyl phthalate. One particularly useful combination of plasticizers for use with a vinyl chloride/vinyl acetate copolymer resin is a mixture of diisodecyl phthalate and diisooctyl phthalate in a weight ratio of about 7-8:1.

It may be desirable to include in the composition, especially when used as a gasket or the like, a material that will increase the permeability of the composition to water, for instance a surfactant such as sodium dodecylbenzene sulphonate or other hydrophilic compounds. A suitable amount of a surfactant is between 0.1 and 10% by weight of the total composition, depending upon the nature of the surfactant. Surfactants may be anionic, non-ionic, and cationic in nature.

The oxygen scavenging composition may be combined with a polymer carrier by combining the oxygen scavenger components with the molten thermoplastic resin with sufficient mixing to allow for uniform dispersion of the oxygen scavenger in the polymer matrix. The initially formed polymer matrix may contain sufficient oxygen scavenger so that it can be used as a concentrate that may be further combined with additional polymeric materials by, for example, melt blending. The polymeric oxygen scavenger composition may comprise from 0.05 to 70 weight % of the oxygen scavenger, or from a lower limit of about 1, 5, 10 or 20% to an upper limit of about 20, 30, 40, 50 or 70 weight %. When prepared as a concentrate, the composition may comprise from 20 to 70 weight %, and from about 0.05 to about 50 weight % when incorporated into a package.

The invention also provides an improved container for packaging materials, such as food, beverages and the like, which are susceptible to oxidative degradation. The improved container is capable of retaining product quality and enhanced shelf life of the packaged material without adversely affecting the color, taste or smell of the packaged material by the presence of the oxygen scavenging composition. It further provides a packaging system which can have high levels of oxygen scavenger agent therein while meeting government regulatory standards related to amounts of such agents contained in food products.

The polymeric oxygen scavenger composition may be formed into various shaped articles useful for packaging materials. The composition can be compounded and extruded, injection molded or thermoformed into desired shapes when the polymer matrix is a thermoplastic resin. The packages described herein may use the common filling and process equipment and operations, or preferably the normal (steam) retort operation after filling, to trigger the oxygen absorption system.

Also provided is a method of protecting an oxidizable product such as moist food from degradation through oxidation in storage, characterized by the steps of fashioning a container from a thermoplastic structure which has at least one layer of a polymeric substance including a moisture-responsive scavenging material that can be activated by moisture to absorb oxygen under predetermined conditions, filling the container with the product and hermetically sealing the container about the product, and subjecting the sealed container to levels of moisture for a preset period of time to activate the material to absorb oxygen within the container.

Preferably, the oxygen scavenging reaction of the composition is accelerated by pasteurizing (typically at 50 to 100° C.) or sterilizing (typically at 100 to 150° C.) the container after filling it with an aqueous fill and sealing it. This triggering appears to be a consequence of the subject composition, when heated, permitting moisture to permeate into the composition and contact the subject oxygen scavenger agent. It is believed that the moisture vapor becomes trapped and condenses in the composition, thereby bringing the scavenger agent into contact with sufficient water to permit reaction with the oxygen present. Oxygen may permeate through the composition either from oxygen trapped within the container when it was filled or which subsequently enters the container from the surrounding atmosphere.

Food packed within impermeable materials such as metal or glass containers by conventional methods with hermetic double seamed ends will include a certain amount of head space gases and entrained oxygen, and the latter will react with some food. It is desirable to keep the head space gases to a minimum, to provide reliable end closuring with hermetic seals, and also to minimize the amount of oxygen present which can react with the container contents. The location of oxygen ingress for such containers may be the seal layer contacting the rim of the container. This invention can be used in the seal layer to reduce undesirable oxygen ingress.

The polymeric oxygen scavenging composition can be embodied in a seal layer of a container such as a can or bottle. Such a container is characterized by a can or bottle and an outer closure of essentially oxygen impermeable material such as metal or glass or polyvinylidene chloride coated plastic. Instead of a can body, the container body can be a bottle or jar and the closure is a cap. The bottle or jar is preferably of glass but it can be of polymeric material with very low oxygen permeability. The closure or cap is preferably metal or a plastic structured to have very low oxygen permeability. The seal layer is located between the rim or lip of the can or bottle and the closure or cap as a sheet free or bonded to the cap or outer closure.

This invention provides a shaped structure containing or derived from the subject composition, as well as to containers, including closures, such as closure seals, closure gaskets, fluid-applied seal compositions (e.g., melt-applied crown cap gasket compositions), cap liner discs, and the like, formed with or containing the subject composition. The role of the scavenger is to scavenge oxygen travelling laterally or radially through the polymer between a metal cap and rimmed bottle. In that case the amount of sulfite scavenger is larger for cases of required longer shelf life of the contents of the can or bottle or for a narrower lip can or bottle. The amount of sparingly soluble sulfite salt can be 0.5% to 50% of the polymeric composition.

Package closures occupy only a minor part of the exposed surface area of the closed container, often less than 25% of the surface area. Thus, the area of the solid deposit of scavenger can be very small relative to the area of the container. Despite this, the invention can give greatly improved storage stability to the contents.

For instance one type of closure, usually a can end, includes at least one, and often two, push components that are defined by partial score lines through the metal panel such that finger pressure can push an area of the panel into the container, so as to allow access to the contents of the container. Thus there may be a small push component to allow release of pressure and a larger push component to allow pouring of liquid from the container. In particular, the scavenger composition may be deposited as an annulus (or a disc) covering the line of weakness. The line of weakness may merely be a weakened line in the metal panel but it can be a total cut around the push component.

A gasket is normally provided between the container body and the closure or cap. This gasket can be used to carry the scavenger composition, in particular, as a polymer matrix containing composition. It is possible for the scavenger composition to be utilized in additional places on the closure or in the container.

Preferably, the gasket or coating on the container closure is formed by applying a fluid or molten composition of the invention formed with a fluid polymer matrix and solidifying it on the closure. The method of application and solidification is generally conventional. It is particularly preferred that the container and can end should both be of metal or the container body should be of glass and the closure of metal or plastic, in which the use of the defined compositions for forming the gasket appears to give particularly beneficial results. In particular, excellent protection from oxygen ingress is achievable when the container body is a glass bottle and the closure is a metal cap and the sealing gasket contains the activated scavenging composition.

The cap can be of polymeric material, for instance polypropylene, that may optionally include a barrier layer in the cap or in the cap liner. Alternatively, the cap may be formed of metal and may include a push or pull component of metal or polymeric material. The cap may be a crown cap such as a pry-off or twist-off crown, a twist-on cap, lug cap, press-on/twist-off, or press-on/pry-off cap, a screw-on cap, roll-on metal cap, continuous thread cap, or any other conventional form of metal cap or polymeric cap suitable for closing the bottle or jar. In any case that portion of the cap liner sealing against the rim of the bottle would contain the oxygen scavenger. The scavenger would limit both radial and axial permeation of oxygen.

When the closure is a cap, the subject scavenger composition may form an overall gasket or a portion of an overall gasket. This is typically true for small diameter caps less than 50 mm in diameter. For large diameter caps, the gasket is in the form of a ring and may be deposited in a conventional manner from the gasket-forming composition. For instance, a ringlike gasket can be formed on a cap by being applied in liquid form as a ring and can then be converted to solid form by drying, heating to cure or cooling to set a thermoplastic, as appropriate. The oxygen scavenging composition is blended into the gasket material. The gasket-forming composition may, for this purpose, be a plastisol, dry-blend, suitable thermoplastic composition or organic solution. The cap, carrying the gasket, is then pressed on to an appropriate sealing face around the open end of the filled container body and closed in conventional manner. Since most gasket polymers are relatively permeable to moisture, the cap should be protected from moisture or oxygen prior to its use in a container.

If the carrier composition is formed with a thermoplastic polymer, it may be applied as a low viscosity melt while the cap is spinning, so as to throw the composition into the form of a ring, or it may be applied as a melt which is then molded into the desired shape, often a disc having a thickened ring-like portion. Further, the gasket can be in the form of a pre-formed ring or disc which is retained (e.g., by mechanical or adhesive means) within the cap.

The invention also includes filled containers sealed with such closures. The sealed container comprises a container body, the closure fitted on it, and the packaged material that is contained within the container body. The container body is preferably of glass or metal. The closure is preferably of metal. The packaged material can be any beverage, foodstuff or other material when retorting is to be applied otherwise the packaged material needs to be such that generates 100% relative humidity in the head space but the invention is of particular value when the filling is a material whose shelf-life or product quality is normally restricted due to oxygen ingress during storage. The container body can be a can, generally of metal, and the closure is a can end. The oxygen scavenging composition may be applied on a center panel of the can end or other interior surface in the can, such as applied as a coating of a can.

The scavenger compositions can be formed into films or as a component of a film composition used to prepare flexible packaging, such as bags, or the films can be laminated onto metal stock which can then be formed into cans and closures. Also, the compositions may be included in flexible packaging such as multilayer films or laminates or as a ribbon, patch, label or coating on a thermoplastic bag or lidstock. The polymeric scavenging composition in the form of a film can, for example, be laminated to substrates such as paperboard to form gable-top cartons. The film may further comprise oxygen barrier layers and/or heat sealable layers as described below to provide a multilayer film. The film can be used as a lidding film for rigid containers such as cups, bowls, tubs, cartons, boxes and the like. The multilayer film may also be fashioned into pouches.

The polymeric oxygen scavenging composition may be included as a layer in a multilayer structure. When the scavenger composition is part of a multilayer structure, the scavenger layer may be the surface layer which will be exposed to the inner surface of the resultant package or an inner layer which is covered by a surface layer having sufficient permeability to permit the O₂ and moisture to penetrate into and contact the layer containing the present composition. Thus, the term “exposed to the interior”, as used herein shall mean that relative to the location of the package's oxygen barrier component there is either direct or indirect exposure of the subject composition to the inner atmosphere of a sealed container having packaged product contained therein.

For example, the invention provides an oxygen scavenging structure for use in protecting the contents of containers against oxidation, wherein the structure includes a passive oxygen barrier layer (such as metal, PVDC, glass, alternating ethylene carbon monoxide copolymer, aromatic polyester, or EVOH) which is substantially impermeable to the flow of oxygen and is located toward the exterior, an activatable layer or component, located toward the interior, which has a first state that is non-activated (and will not absorb oxygen) and has a second active state wherein it chemically combines or reacts with oxygen, wherein a change from the first non-active state to the second active (oxygen scavenging) state can be carried out in combination with a packaging operation. The structure has enhanced resistance to oxygen transmission, characterized in that the structure includes at least one layer of a polymeric substance which includes a composition as described herein which in a dry condition is substantially passive and will not absorb oxygen and which in a sufficiently moist condition is activated to scavenge oxygen in the course of transmission through the structure. This structure can form the basis of a packaging material or container.

A multilayer structure for a polymeric container suitable for food can be constructed from a plurality of layers each of which is selected to perform particular functions. The outer and inner layers are usually structural and protective layers chosen to exclude the outside elements and to contain the food, respectively. Between these layers are materials designed to control the unwanted permeation of oxygen, including an oxygen barrier layer and a layer of the polymeric oxygen scavenging composition located toward the interior of the package relative to the oxygen barrier layer. The outermost layer which is designed to impart structural integrity to the construction, can be an olefinic thermoplastic material for its low cost, easy formability and physical characteristics. Similarly, the innermost layer also has a structural or sealing function and can likewise be fashioned from materials compatible with food, low in cost and easily formed.

A preferred multilayer structure has olefinic outer and inner layers resistant to the transmission of water vapor at room temperature, but at elevated temperature and steam pressure, e.g. during retorting, they permit water vapor to permeate to the oxygen absorbing system and activate the scavenger.

In between the two structural layers a thermoplastic oxygen barrier layer is located. Suitable barrier materials may include ethylene vinyl alcohol co-polymers, such as produced by Kuraray of Tokyo, Japan; Nippon Gohsei of Osaka, Japan; or Chang Chun Plastics Co., LTD of Taipei, Taiwan, having low permeability with respect to the transmission of oxygen. It is advantageous to sandwich the oxygen barrier layer between a pair of outer and inner protective layers to provide a combination of packaging properties for the entire packaging structure. Between the barrier layer and its neighboring layers co-extrudable adhesive may be included to assure proper integrity between the outer and inner layers and the barrier layer. The adhesive may comprise materials such as polyethylene or polypropylene homo- or copolymers grafted with 0.1% to 4% maleic anhydride or itaconic anhydride optionally blended with other polymers. Such materials are available commercially from E.I. du Pont de Nemours (DuPont) under the Bynel® tradename. In some embodiments, the oxygen scavenging composition may be incorporated into the adhesive layer.

In a multilayer plastic container a system to absorb oxygen is of extreme importance because, however excellent, a passive oxygen barrier only partially reduces the permeation of the oxygen into the container. A system that will absorb or react with oxygen that passes through the barrier, and which is located between the barrier and the food is thus desirable, especially for retort packaging. Plastic containers using EVOH barrier experience “retort shock” which is a temporary very high ingress rate of oxygen after being retorted because EVOH oxygen barrier is damaged by the presence of moisture. During periods of several weeks to months of such “retort shock” it is most advantageous to have an active oxygen barrier (i.e. a scavenger) consuming the oxygen that permeates through the EVOH. More particularly for removing oxygen trapped in the container head space during sealing, an oxygen scavenging system having a greater affinity for oxygen than the food is desirable. Ideally, such a system should have a faster reaction rate with oxygen than does food and hence should be capable of removing oxygen sufficiently enough to protect the contained food.

The scavenging composition when used for any layer between the EVOH and the contents of the package is triggered by the retort process to start acting as an oxygen barrier during the time when EVOH is not functional as a barrier. The amount of the scavenging composition designed into the package may be adjusted to be only enough necessary for the temporary period of time when EVOH is not functional. Alternatively additional amount of the composition may be used to extend the life expectancy of the overall barrier system or else to reduce the amount of EVOH needed in the structure.

The oxygen scavenger should be present in an amount to effectively scavenge oxygen during the contemplated storage period of the container for the appropriate contents. The amount of oxygen scavenging agent will depend on the anticipated application of the scavenging composition. When the sulfite chemistry is contained in a thick walled polymeric container (such as 40 mil) having a thick layer of EVOH (such as 2 mil) the amount of oxygen scavenging sulfite agent can be as low as about 0.05 weight percent of the polymer composition and preferably at least 0.1 weight percent of the composition. When the sulfite chemistry is contained in a thin walled container (such as 2 mil) having a thin layer of EVOH (such as 0.2 mil) the amount of oxygen scavenging sulfite agent can be as high as about 13 weight % of the composition and preferably at least 20 weight % of the composition. Generally speaking, the sparingly soluble sulfite scavenger component of the scavenging system may be used in the range of 0.05 to 30% based on total weight of the polymer layer between the EVOH barrier and the contained food.

A preferred multilayer embodiment comprises several types of thermoplastic compositions, the outer and inner layers being sealing and non-sealing polyolefinic or olefinic and an interior layer being the passive oxygen barrier layer. Between the barrier and olefinic layers are adhesive layers to assure structural integrity. Either or both adhesive layers may include an oxygen scavenging system. The oxygen scavenging layer may alternatively be included in the inner structure layer. Locating the oxygen absorbing system between the passive oxygen barrier and the food is preferred for a long active life expectancy of the scavenging compound. The inner structure layer may also be prepared from material suitable for sealing, such as by heat sealing, to itself or to other materials as the innermost layer (facing the contents) of the packaging structure to facilitate assembly and/or closure of the package.

The invention can be used in the manufacture of multilayer polymeric containers by film or sheet extrusion, injection or extrusion molding techniques of molten polymers or by thermoforming solid amorphous polymer sheets. Such plastic multilayer containers can then be sold to food and beverage packers without concern that the oxygen absorption system will be degraded during the time between manufacture and use.

The structure can be a blow-molded or thermoformed container. Such a container can be characterized by a wall including an outer olefinic layer, a passive oxygen barrier layer, a polymeric layer including the scavenging composition and an innermost olefinic layer, the olefinic layers or a further layer being of low permeability to moisture for protecting the active oxygen scavenger from activation by ambient humidity prior to thermoforming and use in a container, but being permeable to moisture at the latter conditions of retort for activating the said composition to an active, scavenging state.

In addition to use in metal, glass and plastic containers, the compositions can be used in a cardboard or paper container such as a juice box. Such a container is a cardboard carton or tube with an interior liner. The composition can be placed in or laminated to the interior liner of the cardboard package, along a line of weakness at the package closure, or at any other convenient location in the package. The compositions can also be used in conjunction with or as a portion of a tamper-evident membrane for pharmaceuticals and foods.

### EXAMPLES

The following examples are given for illustrative purposes only and are not meant to be a limitation on the teaching herein or on the claims appended hereto. All parts and percentages are by weight unless otherwise stated.
Materials
Calcium Sulfite (MW=120.2) CAS 10257-55-33, commercial grade obtained from City Chemicals LLC, lot number 21H125, grain diameters between 3 and 5 microns.
Potassium carbonate (MW=138.2) commercial grade.
Ethylenediaminetetraacetic acid disodium salt dihydrate (EDTA-Na) (MW=372.24) commercial grade
Potassium acetate (MW=98.1, Melt=292° C.), commercial grade obtained from Aldrich, catalog number 236497.
Alum: Aluminum potassium sulfate·12H₂O (MW=474.4, Melt=92° C.), commercial grade obtained from Aldrich, catalog number 237086. DSC analysis showed that 40% of hydration water is lost when heated at 100° C.
PP-1: polypropylene PP6523 commercially available from Lyondell Basell (formerly Montell).

The solid materials are mixed as summarized in Table 1 and then ground with mortar and pestle to provide homogeneous fine powders. The powders were charged to air-filled glass vessels, approximately 7 cm long, with diameter of about 5.5 cm, volume of about 140 cc, equipped with an oxygen sensor available from Sable Systems International (6000 S. Eastern Ave. Bldg 1, Las Vegas Nev. 89119, USA). Oxygen uptake analysis was conducted according to the following general procedure. A 5 ml open beaker of water was placed inside the vessel to provide a nearly 100% relative humidity (the solids are not added to this water but are separate, outside this beaker). The oxygen analysis consumes a small amount of oxygen during the run so there was a baseline drift of about 0.2%/day. Therefore, the percentage of oxygen in the vessel after 2.5 days was corrected by the addition of 0.5%.

The pH of the compositions was measured by adding 0.1 g of the formulation composed of CaSO₃ with the proportional amounts of other components of the formulation into 10 grams of deionized water. After about one minute stirring the pH was measured.

TABLE 1

| | | | | Water Attractor | | | | | | |
|---|---|---|---|---|---|---|---|---|---|---|
| | | | | | Measured % | | | | | |
| | | | | | RH above | | | | | |
| | | | | | saturated | | pH of the | Charged to O₂ test vessel | | |
| | CaSO₃ | Acidifier | | | solution | | formulation | Blend | Total SO₃ | % O₂ drop |
| Example | g | type | g | type | (reported) | g | with CaSO₃ | sample (g) | (millimoles) | in 2.5 days |
| C1 | Na₂SO₃ | | 0 | | NA | 0 | NA | 0.03 | 0.24 | 1.1 |
| C2 | CaSO₃ | | 0.00 | | | 0.00 | 7.0 | 0.056 | 0.50 | 0.3 |
| C3 | 1.1 | | 0.00 | K₂CO₃ | 42 (43) | 0.22 | 11.0 | 0.067 | 0.49 | 0.3 |
| 1 | 0.6 | EDTA-Na | 0.86 | | | 0.00 | | 0.140 | 0.49 | 1.2 |
| 2 | 0.6 | EDTA-Na | 0.86 | K₂CO₃ | 42 (43) | 0.11 | | 0.150 | 0.55 | 1.4 |
| C4 | 1.38 | Ferrous | 0.12 | | | 0.00 | | 0.061 | 0.47 | 1.0 |
| | | sulfate | | | | | | | | |
| C5 | 0.70 | Ferrous | 0.80 | | | 0.00 | | 0.121 | 0.47 | 1.4 |
| | | sulfate | | | | | | | | |
| 3 | 0.73 | Adipic | 0.77 | | | 0.00 | | 0.115 | 0.47 | 2.1 |
| | | acid | | | | | | | | |
| 4 | 0.73 | Stearic | 0.77 | | | 0.00 | | 0.115 | 0.47 | 0.9 |
| | | acid | | | | | | | | |
| 5 | 1.36 | alum | 0.14 | | | 0.00 | 5.0 | 0.062 | 0.47 | 3.1 |
| 6 | 0.73 | alum | 0.77 | | | 0.00 | 4.0 | 0.115 | 0.47 | 3.2 |
| 7 | 0.50 | alum | 1.00 | | | 0.00 | | 0.168 | 0.47 | 4.5 |
| C6 | 0.58 | alum | 0.61 | CaCl₂—6H₂O | 30 (31) | 0.31 | 4.5 | 0.144 | 0.47 | 0.0 |
| 8 | 0.58 | alum | 0.61 | ZnCl₂ | 17 (10) | 0.31 | 4.5 | 0.144 | 0.47 | 0.9 |
| 9 | 0.58 | alum | 0.50 | NaCl | (75) | 0.25 | 4.0 | 0.128 | 0.47 | 1.7 |
| 10 | 0.58 | alum | 0.50 | NaCl | (75) | 0.25 | 4.0 | 1.300 | 4.83 | 1.1 |
| 11 | 1.36 | alum | 0.50 | KF | (20) | 0.25 | 6.0 | 0.087 | 0.47 | 1.6 |
| 12 | 1.36 | alum | 0.50 | KF | (20) | 0.25 | 6.0 | 2.100 | 11.31 | 11.8 |
| 13 | 1.38 | alum | 0.50 | K₂CO₃ | (43) | 0.03 | 4.5 | 0.077 | 0.47 | 1.9 |
| 14 | 1.38 | alum | 0.50 | K₂CO₃ | (43) | 0.03 | 4.5 | 1.900 | 11.48 | 18.0 |
| 15 | 0.50 | alum | 0.50 | KO₂CCH₃ | 25 (20) | 0.13 | 4.5 | 0.126 | 0.47 | 2.9 |
| 16 | 0.58 | alum | 0.61 | KO₂CCH₃ | 25 (20) | 0.31 | 4.5 | 0.144 | 0.47 | 5.2 |
| 17 | 0.50 | alum | 0.50 | KO₂CCH₃ | 25 (20) | 0.13 | 4.5 | 1.100 | 4.16 | 21.0 |
| 18 | 0.73 | alum | 0.50 | Zn-acetate | | 0.25 | 4.5 | 0.113 | 0.47 | 4.0 |
| 19 | 0.73 | alum | 0.50 | Zn-acetate | | 0.25 | 4.5 | 1.500 | 6.07 | 18.5 |

As indicated in Table 1, sodium sulfite (Comparative Example C1) without additives provided oxygen scavenging, but calcium sulfite (Comparative Example C2) provided little to no scavenging. Provided it is a free salt (that is, not melt blended into polymer), the scavenging capacity is 100% of theory which means one mole of dioxygen is consumed per two moles of sulfite.

Sodium sulfite may be sufficiently water soluble or hygroscopic to allow formation of hydrosulfite ion in a humid atmosphere, but sparingly soluble calcium sulfite is not. Addition of highly soluble and hygroscopic potassium carbonate to the calcium sulfite also failed to provide scavenging, possibly due to hindering formation of hydrosulfite due to its basicity (Comparative Example C3). Comparative Examples C4 and C5 showed that ferrous sulfate in combination with calcium sulfite provided oxygen scavenging.

Table 1 shows the benefit to increased oxygen scavenging of CaSO₃ formulations by addition of an acid source. Enhanced oxygen scavenging was obtained when the pH of a solution of the formulation was less than 7 and preferably less than 6. Addition of an acid source, such as EDTA sodium salt, to calcium sulfite provided good oxygen scavenging (Example 1). The three-component system of CaSO₃+EDTA-Na+K₂CO₃ showed scavenging, the EDTA-Na being of sufficient quantity to counter the alkalinity of K₂CO₃ (Example 2). Use of organic acids such as stearic acid or adipic acid provided scavenging (Examples 3 and 4).

Examples 5, 6 and 7 showed that addition of alum, AlK(SO₄)₂, as an acid source to CaSO₃ activated the CaSO₃ to scavenge oxygen, providing excellent scavenging. Examples 13 and 14 show that alum is sufficiently acidic to promote oxygen scavenging, even with added potassium carbonate.

Addition of soluble Group II salts may inhibit oxygen scavenging as exemplified by Comparative Example C6. It is believed that the presence of excess solubilized Group II cations hinder the required solubilization of sulfite anions necessary for their reaction with oxygen. Halide salts with zinc or Group IA cations did not show improvement in scavenging (Examples 8-12) compared to similar compositions without such salts.

Addition of hygroscopic water-attracting salts to the alum-CaSO₃ combination may also provide improved scavenging. Addition of acetate salts such as potassium acetate or zinc acetate to the combination of CaSO₃ and alum provided excellent oxygen scavenging (Examples 15, 16, and 18).

Amounts of the solid salts as summarized in Table B were added to melted polypropylene in a batch melt blender (manufactured by Rheometer Services Inc. of Ocean, N.J.) using Type 6 rollers at about 185° C. and 125 rpm for about five minutes of mixing. The resultant compounded material was removed from the batch mixer as a “plop” which was stored protected from water and oxygen at room temperature.

Molded sheets for testing were prepared by compression molding three 20 mil sheets from all 5 samples. Molding involved placing about 4 grams of each composition on a Teflon® fluoropolymer-coated aluminum foil sheet on a platen heated to 190° C., heating for about 1 minute with application of about 15,000 psi pressure constrained by a 20mil-thick template, holding for one minute, releasing pressure and cooling to 22° C.

Immediately before retorting, the molded sheets of each sample were cut into eight 0.75 inch×2 inch strips for subsequent O₂ scavenging tests. The weights of each eight-strip set was recorded (each around 4 grams). The strips were steam retorted for 45 minutes at 121° C. with minimal oxygen exposure. The strips were supported on racks so that they were not immersed in water. After retorting there was a 30 minutes cool-down period so the sample once activated may have been exposed to air for about one hour.

Immediately following the retorting process, the retorted strips were placed in Sable oxygen vessels equipped with an oxygen sensor available from Sable. Oxygen uptake analysis was conducted according to the following general procedure. A small beaker of deionized water to provide 100% relative humidity during oxygen analysis was placed in the vessel. The oxygen analysis consumes a small amount of oxygen during the run so there is a baseline drift of about 0.2%/day. The percentage of oxygen in the vessel was determined at periodic intervals. The results are summarized in Table 2.

Duplicate samples from each of the sheets were taken for analysis of sulfite migration into water during the retort process. Four 2-cm diameter discs (prepared for sulfite extraction) were cut from the 5 samples and a polypropylene control. The weights of each set were recorded. Each 4-disc set was placed inside scintillation glass containers completely covered with 3 ml of deionized water with the lid placed loosely on. The vessels were retorted for 45 minutes at 121° C. with minimal oxygen exposure. The final amount of water in each of the vessels was determined to be about 2.9 g and the discs were removed. The remaining water was kept in the vessels and the vessels were capped tightly. The water was analyzed by inductively coupled plasma-optical emission spectrometry. The results are summarized in Table 2.

From the data in Table 2, polypropylene containing Na₂SO₃ releases sulfite to the ambient water during the retort process roughly proportionally to the total sulfite level in the sheet (Comparative Example C7). This is true whether the sheet is monolayer or multilayer with a layer of ethylene vinyl alcohol copolymer. There was some variability in the amount of oxygen scavenged per sulfite, possibly due to variations in mixing the salt into the polymer matrix. Addition of EDTA-Na and potassium carbonate inhibited oxygen scavenging and increased sulfite extraction during retort (Comparative Example C8).

Comparative Example C10 showed that polypropylene containing calcium sulfite or calcium sulfite blended with EDTA-Na and potassium carbonate showed no oxygen scavenging, but extraction of sulfite into water during retort was significantly reduced compared with results for sodium sulfite (Comparative Example C8).

Addition of alum at 0.36% based on the total of the polymeric composition (Example 20) increased the rate/capacity of oxygen scavenging by CaSO₃ from a negligible level (Comparative Example C9) to about 0.1% per 2.5 days. Higher levels of alum further increased the oxygen scavenging (Example 21). Addition of potassium acetate further helps as shown by comparison of Comparative Example C9 (no additive, 0% oxygen consumed) and Example 20 (alum alone, 0.1% oxygen consumed in 2.5 days) with Example 22 (alum with potassium acetate, 0.7% oxygen consumed in 2.5 days) or Example 21 (alum alone, 1.4% oxygen consumed in 2.5 days) with Example 23 (larger amount of alum with potassium acetate, 2% oxygen consumed in 2.5 days).

The data in Table 2 demonstrate that under retorting conditions significantly more sulfite was extracted from the polymer sample containing Na₂SO₃ than samples containing CaSO₃, even when the CaSO₃ was combined with hygroscopic potassium acetate. Polypropylene with no additives introduced a non-detectable amount of sulfite (expressed as sulfur in parts per million), that is, less than 10 ppm. Polypropylene containing Na₂SO₃ (Comparative Example C7) gave 770 ppm of extracted sulfite-sulfur to the 3 ml of water during the retort process and CaSO₃ with alum (Example 21) gave 81 ppm of extracted sulfite-sulfur to the 3 ml of water during the retort process. Both example compositions scavenged the same amount of oxygen (1.4% in 2.5 days).

The data in the Examples of Table 2 show that we have successfully decoupled the unwanted sulfite extraction during retort exemplified with soluble sulfite salts from the desired oxygen scavenging by sulfite post-retort by using calcium sulfite combined with aluminum-potassium sulfate and (optionally) potassium acetate, zinc acetate or zinc chloride. This calcium sulfite system reduces the sulfite extraction into desirable levels. The more optimal compositions were lower (not zero) in alum and demonstrated 30-fold reduction of sulfite extraction levels and a 10-fold better scavenging efficiency (amount of oxygen scavenged per amount of sulfite extracted) than sodium sulfite.

TABLE 2

| | | | | | | | | | | sulfur | |
|---|---|---|---|---|---|---|---|---|---|---|---|
| | | | | | | | | | | (sulfite) | |
| | | | | | | | | | | released into | mM O₂ |
| | | | | | | | Charged to O₂ vessel | | O₂ drop in | 3 ml H₂O | consumed per |
| | | acidifier | | water attractor | | PP | Polymer | Total SO₃ | 2.5 days | during retort | mM of sulfite |
| code | | type | (g) | type | (g) | (g) | sample (g) | (millimoles) | (%) | (ppm) | extracted |
| | Na₂SO₃ | | | | | | | | | | |
| | (g) | | | | | | | | | | |
| C7 | 5.6 | | 0.00 | | 0.00 | 49.4 | 4.13 | 3.34 | 1.4 | 770 | 1.3 |
| C8 | 2.28 | EDTA-Na | 2.28 | K-carbonate | 0.46 | 50.0 | | 0.66 | 0.2 | 1070 | 0.1 |
| | CaSO₃ | | | | | | | | | | |
| | (g) | | | | | | | | | | |
| C9 | 9.1 | | 0.00 | | 0.00 | 45.7 | 4.02 | 5.53 | 0.0 | 10 | 0.0 |
| C10 | 2.3 | EDTA-Na | 3.61 | K-carbonate | 0.46 | 48.6 | | 0.70 | 0.0 | 72 | 0.0 |
| 20 | 9.10 | alum | 0.20 | | 0.00 | 45.7 | 3.78 | 5.20 | 0.1 | 29 | 2.5 |
| 21 | 8.90 | alum | 1.80 | | 0.00 | 44.4 | 3.73 | 5.02 | 1.4 | 81 | 12.6 |
| 22 | 9.10 | alum | 0.20 | K-acetate | 0.20 | 45.6 | 4.09 | 5.63 | 0.7 | 52 | 9.8 |
| 23 | 8.80 | alum | 1.80 | K-acetate | 0.20 | 44.2 | 3.76 | 5.00 | 2.0 | 104 | 14.0 |
| 24 | 8.4 | | 0.00 | K-acetate | 1.00 | 45.6 | 4.01 | 5.10 | 0.7 | 49 | 10.4 |
| 25 | 9.2 | | 0.00 | ZnCl₂ | 0.20 | 45.6 | 4.03 | 5.55 | 0.7 | 62 | 8.2 |
| 26 | 9.0 | alum | 0.20 | ZnCl₂ | 0.20 | 45.6 | 4.07 | 5.54 | 0.8 | 52 | 11.2 |
| 27 | 9.0 | alum | 0.20 | ZnCl₂ | 0.20 | 45.6 | 3.98 | 5.48 | 1.7 | | |
| 28 | 9.1 | citric acid | 0.20 | | 0.00 | 45.7 | 4.02 | 5.53 | 0.7 | 80 | 6.4 |

1. An oxygen scavenging composition comprising
(a) a sparingly soluble salt of a divalent cation selected from Group IIA of the periodic table and sulfite;
(b) an acidifying compound, characterized by the condition that the pH of a solution of 0.1 grams of the acidifying compound in 10 grams of deionized water after 2 minutes of stirring is from about 2 to about 6; and optionally
(c) a hygroscopic compound characterized by the condition that the relative humidity above a supersaturated solution of the hygroscopic compound is less than 30%;
wherein the pH of a solution of 0.1 grams of the mixture of (a), (b), and (c) in 10 grams deionized water after 2 minute stirring is in the range from 2 to 7; provided that (b) and (c) are not ferrous compounds.

2. The oxygen scavenging composition of claim 1 wherein the pH of a solution of 0.1 grams of the mixture of (a), (b), and (c) in 10 grams deionized water after 2 minute stirring is in the range from 3 to 6.

3. The oxygen scavenging composition of claim 1 wherein the pH of a solution of 0.1 grams of the mixture of (a), (b), and (c) in 10 grams deionized water after 2 minute stirring is in the range from 4 to 6.

4. The oxygen scavenging composition of claim 1 wherein the hygroscopic compound is present in the composition.

5. The oxygen scavenging composition of claim 1 further comprising a polymer matrix, in a range of 0.05 to 70 weight % of the total polymeric oxygen scavenging composition.

6. The oxygen scavenging composition of claim 5 wherein the scavenging composition comprises 0.05 to 50 weight % of the total polymeric oxygen scavenging composition.

7. The oxygen scavenging composition of claim 5 wherein the polymer matrix comprises polyethylene, polypropylene, ethylene/propylene copolymers, acid modified ethylene/propylene copolymers, polybutadiene, butyl rubber, styrene/butadiene rubber, carboxylated styrene/butadiene, polyisoprene, styrene/isoprene/styrene block copolymers, styrene/butadiene/styrene block copolymers, styrene/ethylene/butylene/styrene block copolymers, ethylene/vinyl acetate copolymers, ethylene/alkyl acrylate and ethylene/alkyl methacrylate copolymers, ethylene/vinyl alcohol copolymers, ethylene or propylene/carbon monoxide alternating copolymers, polyvinyl chloride homopolymers and copolymers, polyvinylidene dichloride polymers and copolymers, styrene/acrylic polymers, polyamides, vinyl acetate polymers, polyethylene or polypropylene homo- or copolymers grafted with 0.1% to 4% maleic anhydride or itaconic anhydride, or blends thereof

8. An article comprising the oxygen scavenging composition of claim 5.

9. The article of claim 8 that is in the form of a film or sheet.

10. The article of claim 9 that is in the form of a multilayer film or sheet comprising outer and inner structural and protective layers, an interior oxygen barrier layer and an interior layer comprising the polymeric oxygen scavenging composition.

11. The article of claim 10 wherein the oxygen barrier layer comprises ethylene vinyl alcohol copolymer.

12. The article of claim 8 that is in the form of a blow-molded or thermoformed container.

13. The article of claim 12 that comprises a multilayer structure comprising outer and inner structural and protective layers, an interior oxygen barrier layer and an interior layer comprising the polymeric oxygen scavenging composition.

14. The article of claim 13 wherein the oxygen barrier layer comprises ethylene vinyl alcohol copolymer.

15. The article of claim 8 that is a closure seal, closure gasket, or cap liner disc.

16. The article of claim 15 wherein the polymeric matrix comprises polyvinyl chloride homopolymers and copolymer or ethylene vinyl acetate copolymer.

17. A method for protecting a food item from degradation due to oxidation comprising
(1) preparing a package comprising the oxygen scavenging composition of claim 1;
(2) placing the food item in the package; and
(3) sealing the package with the food item inside.

18. The method of claim 17 wherein the oxygen scavenging composition is contained in a polymer matrix, in a range of 0.05 to 50 weight % of the total polymeric oxygen scavenging composition.

19. The method of claim 18 wherein the package comprises a film or sheet comprising the polymeric oxygen scavenging composition.

20. The method of claim 19 wherein the film is a multilayer film or sheet comprising outer and inner structural and protective layers, an interior oxygen barrier layer and an interior layer comprising the polymeric oxygen scavenging composition.

21. The method of claim 20 wherein the oxygen barrier layer comprises ethylene vinyl alcohol copolymer.

22. The method of claim 18 wherein the package comprises a blow-molded or thermoformed container comprising the polymeric oxygen scavenging composition.

23. The method of claim 21 wherein the blow-molded or thermoformed container comprises a multilayer structure comprising outer and inner structural and protective layers, an interior oxygen barrier layer and an interior layer comprising the polymeric oxygen scavenging composition.

24. The method of claim 18 wherein the package comprises a closure seal, closure gasket, or cap liner disc comprising the polymeric oxygen scavenging composition.

25. The method of claim 7 further comprising
(1) treating the sealed package with steam at a temperature of 110 to 130° C. for 10 to 60 minutes;
(2) cooling the treated package to 20 to 30° C.; and
(3) storing the package for a period of time.
